(19) United States
(12) Patent Application Publication
(10) Pub. No.: US 2023/0174196 A1
(43) Pub. Date: Jun. 8, 2023

(54) Steering assisted heeling in gyration

(71) Applicant: SEAIR, 56100 LORIENT (FR)

(72) Inventor: Castelnerac Bertrand, LORIENT (FR)

(21) Appl. No.: 17/803,296

(22) PCT Filed: Sep. 30, 2020
(86) PCT No.: PCT/EP2020/077366

§ 371 Date: Apr. 28, 2022

(30) Foreign Application Priority Data
Nov. 4, 2019 (FR) 1912326

(51) Int. Cl. B63B 1/28; B63B 1/26

(52) U.S. Cl. CPC B63B 1/285; B63B 1/26

(57) ABSTRACT

Device for adjusting heel in boat turn, monohull, motorized, on pair of foils (10b, 10t) and steered by a steering wheel (1) which steers a rudder characterized in that the steering wheel comprises a system of assistance by a hydraulically assisted (3, 8) on which is added a distributor (5) which jointly supplies the directional control of the rudder (8) and each of the two jacks (20b, 20t) for controlling the two port (10b) and starboard (10t) in a symmetrical inverted movement called front/rear rake around a pivot (22) of each of the foils (10) on the hull of the boat.

The present invention relates to an assisted steering for motorized monohull boat on pair of foils. Foils are wings that are placed below the water level and give lift to the boat. A pair of foils means a port foil and a starboard foil positioned opposite each side of the hull.

The existing motorized monohulls on a pair of foils are poorly suited to tonic piloting at high speed. Indeed, the principle of a boat on foil is that when the foils are deployed the lift is mainly or totally on the foils. In this case, there is a real problem in the turns taken sharply or quickly, with a boat that no longer leans enough. On the other hand, on a traditional motorized monohull, in turns, the geometry of the hull, which is V or U-shaped, will automatically lean the boat on the inside of the turn. Insufficient heeling on boats on foils in bends is very disturbing for passengers and can present a material or physical danger with the effect of centrifugal force which pushes the free masses on the deck of the boat outwards ship.

A main object of the invention is to provide a heel adjustment system which is activated in turns, for a motorized monohull on a pair of foils.

An object of the invention is in particular to propose a solution adapted to the different ranges of motorized monohulls, from that which occupies the bottom of the market to those which occupy the top of the market. The invention aims to provide a solution which is not too expensive, and which does not require too much work for the aftermarket. The invention also aims to propose a solution which is simple for the user and which does not require computing. Indeed, advanced technology has a cost, a complexity and also a maintenance and a reliability that are not suitable for certain types of use.

An object of the invention is to provide a solution which is easily adjustable and adaptable for the different navigation conditions.

The prior art does not offer any solution that makes it possible to adjust the heel of monohull boats on foils when turning.

In a main aspect, the invention proposes to couple the power steering of the steering wheel to a power steering of the heel. By cleverly combining the steering wheel's hydraulic power steering system with a parallel mounting of heeling power steering activating an advanced mechanical foil servo system, it is possible to offer a stable, solid and long-lasting heeling solution. for motorized monohull boat on pair of foils.

In one aspect, the heeling adjustment is carried out by adjusting the incidence of the foils.

More particularly, the invention aims to increase the lift of the foil arranged on the outside of the turn and to reduce that of the foil arranged on the inside of the turn.

More specifically, it is the action of the user on the steering wheel of the boat which acts on the hydraulic foil steering system, which modifies the relative lift of the inner and outer foils and which therefore gives inclination to the boat.

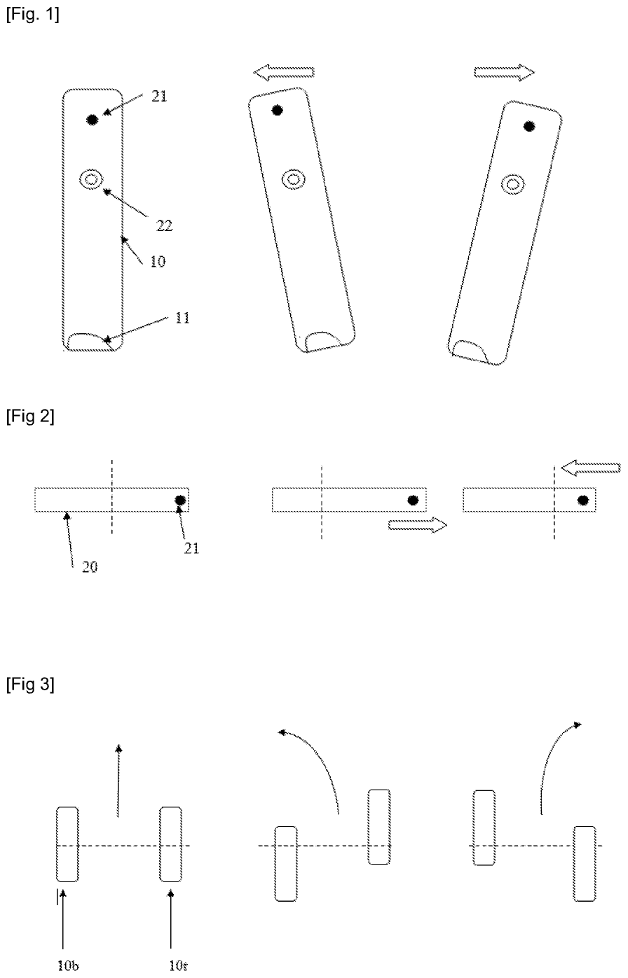

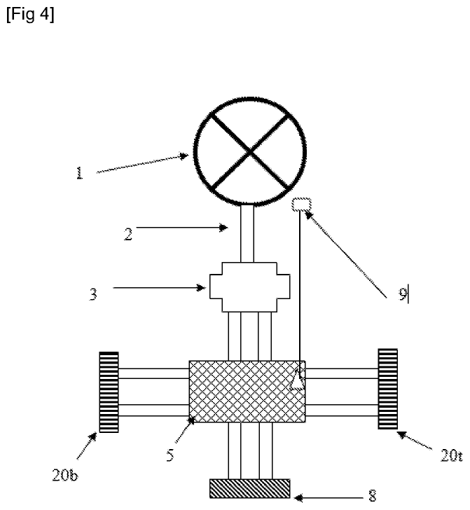

Invention will be better understood with the detailed figures on which:

[FIG. 1] shows in profile the principle of foil actuation in accordance with the present invention

[FIG. 2] represents a profile view of the principle of the actuation of a foil in accordance with the present invention

[FIG. 3] represents the relative displacement of the two foils coupled in accordance with the present invention

[FIG. 4] shows a top principle view of the foil power steering machinery according to the present invention

[FIG. 1] shows in profile the principle of foil actuation in accordance with the present invention with a foil (10), successively shown in a centered middle position, in a position of positive rotation with respect to the centered position and finally in a position of negative rotation with respect to the centered position. The foil (10) pivots around an axis of rotation (22), and it is controlled in this rotation by an attachment point (21), positioned on the top of the foil (10) above its axis of rotation (22), the grip on the foil (21) is clamped by a jack (20) by known means. In a rotated position, the wing section, generates different lift on the water flow it passes through depending on the proportion of lower surface to upper wing section surface that is exposed to the water flow. This rotational movement therefore has the effect, depending on the direction of rotation, of increasing or decreasing the lift of the wing. The tip of the wing (11) of the foil can also have an asymmetrical shape, which has the effect of amplifying the relative lift effect underwater depending on whether the foil is turned positive or negative.

[FIG. 2] thus represents an alternative embodiment with a translation of the grip on foils (21) obtained by a translation of the jack. Successively represented, if the jack is supplied in the equilibrium position, then the jack (20) in the equilibrium position, then a jack supercharged by the hydraulic circuit which expands and which pushes the foil socket, and finally the jack (20) underpowered by the hydraulic circuit and which contracts and brings back the foil intake. Of course there may be variants of setting the foil in motion, but the mechanical principle is always the same, which is to give a so-called front or rear rake movement to increase at the front or at the rear of the boat the lift of the foil under water. One can for example think of a mechanical equivalent which would be a foil which would unfold laterally around a longitudinal axis with one of the ends of this axis which is itself placed in vertical translation upwards or downwards by the jack (20). In the end, the desired effect is to move forward or backward relatively to each other, the top of the foil to the bottom of the foil, in a movement well known as the so-called rake.

[FIG. 3] represents the coordination of the movement given to the two coupled foils, which are the port foil (10b) and the starboard foil (10t). Shown here is the lower part of the foils, which transmits the relative lift under water. This coordination is explained in the following paragraph. If the boat is moving straight ahead, the port (10b) and starboard (10t) foils are then vertical and parallel. If the boat takes a left turn, then by two reverse rake movements on each of the foils, the lower part of the starboard foil moves back and the lift of this foil increases, and that of the port foil moves forward and its lift decreases. If the boat takes a right turn, the lower part of the starboard foil moves forward and the lift of this foil decreases, and that of the port foil moves back and its lift increases. It is the relative movement of the bottom of the foils under water that gives relative lift to the foils and makes it possible to heel the boat. The art of the mechanic will be to adjust the mechanical system described below so that the heel follows the angle necessary to adopt in order to withstand the centrifugal force applied to the free masses on the deck during the turn.

[FIG. 4] represents the mechanical and hydraulic system that allows this coordination. It comprises a hydraulic pump (3) to which the steering wheel (1) is directly connected. Typically this hydraulic pump (3) supplies a distributor (5) which supplies hydraulics to a port jack (20b), a starboard jack (20t) and a rudder jack (8). The distributor coordinates the volumes of fluids sent to each of the port, starboard and steering foil jack (8). By turning the steering wheel, the pilot therefore controls several coordinated actions, namely 1—the movement of the rudder to steer the boat 2—the inverted movement of the two port jack (20b) and starboard jack (20t). This last forward-backward movement of rake is done around a determined position of equilibrium, which in the basic setting of the boat in a straight line, is given for two parallel vertical foils. This balance position can be changed by a balance control (9) next to the steering wheel which adjusts the setting of the splitter (5) to change the timing of the balance position of the two side foils.

The present invention therefore relates to a boat turning heel adjustment device, monohull, motorized, on a pair of foils (10b, 10t) and controlled by a steering wheel (1) which controls the direction of the boat at the foils and the lateral lifts of the foils, characterized in that the steering wheel comprises an assistance system by hydraulic power steering (3, 8) to which is added a distributor (5) which coordinates the hydraulic supply of the directional steering of the rudder (8) and that of each of the two jacks (20b, 20t) for piloting the two port (10b) and starboard (10t) foils held to the jacks by a grip on the foils (21) in a symmetrical inverted movement called a front/rear rake around a pivot (22) of each of the foils (10) on the hull of the boat to accompany the lift of the foils in the turning movement given by the steering wheel.

The present invention therefore relates to a boat turning heel adjustment device, monohull, motorized, on a pair of foils (10b, 10t) according to claim 1 characterized in that the position of equilibrium around which the inverted movement of the port (10b) and starboard (10t) foils is adjustable by a balance control actuator (9) close to the steering wheel which acts jointly on the distributor (5) and on the attachment position (21) on foils (10)

1. Monohull, motorized boat turning heel adjustment device, on a pair of foils (10b, 10t) and steered by a steering wheel (1) which steers a rudder characterized in that the steering wheel comprises a system of assistance by hydraulic power steering (3, 8) to which is added a distributor (5) which coordinates the hydraulic supply of the rudder steering (8) and that of each of the two jacks (20b, 20t) for steering the two port (10b) and starboard (10t) foils held to the jacks by a grip on the foils (21) in a symmetrical inverted movement called a forward/backward rake around a pivot (22) of each of the foils (10) on the hull of the boat to accompany the lift of each of the foils under water in the turning movement given by the steering wheel (1)

2. Device for adjusting heel when turning a boat, monohull, motorized, on a pair of foils (10b, 10t) according to claim 1, characterized in that the position of equilibrium around which the inverted movement of the foils takes place port (10b) and starboard (10t) is adjustable by a balance control actuator (9) close to the steering wheel which acts jointly on the distributor (5) and on the position of the grip on the foils (21) of the foils (10).
